(19) United States
(12) Patent Application Publication
(10) Pub. No.: US 2026/0173215 A1
(43) Pub. Date: Jun. 18, 2026

(54) ADJUSTABLE MIRROR ARRANGEMENTS FOR PROCESS CHAMBERS, AND RELATED METHODS AND APPARATUS

(71) Applicant: Applied Materials, Inc., Santa Clara, CA (US)

(72) Inventor: Abbas RASTEGAR, Schenectady, NY (US)

(21) Appl. No.: 18/982,772

(22) Filed: Dec. 16, 2024

(51) Int. Cl. H05B 1/02; G02B 26/08

(52) U.S. Cl. CPC H05B 1/0233; G02B 26/0816

(57) ABSTRACT

The present disclosure relates to a heating apparatus including adjustable mirrors for process chambers, and related methods and apparatus for semiconductor manufacturing. In one or more embodiments, a process chamber includes a chamber body at least partially defining a processing volume. A substrate support is disposed in the processing volume. A plurality of heat sources are operable to heat the processing volume. A support plate is disposed outwardly of the processing volume. One or more reflective surfaces are mounted to the support plate. The one or more reflective surfaces are operable to direct radiation to a target location in the processing volume by moving about at least one axis.

### BACKGROUND

### Field

The present disclosure relates to a heating apparatus including adjustable mirrors for process chambers, and related methods and apparatus for semiconductor manufacturing.

### DESCRIPTION OF THE RELATED ART

Semiconductor substrates are processed for a wide variety of applications, including the fabrication of integrated devices and microdevices. During processing, various parameters can affect the uniformity of material deposited on the substrate. For example, the temperature of the substrate and/or temperature(s) of processing chamber component(s) can affect deposition uniformity.

It can be difficult to adjust parameters (such as temperature) for deposition uniformity. Precise control over a heating source allows a substrate to be heated within tolerances. The temperature of the substrate can affect the uniformity of the material deposited on the substrate. For example, film thickness non-uniformities can occur across a substrate in a non-uniform manner. It can be difficult to adjust process parameters, such as temperature and/or film growth. Adjustments can also involve opening of the process chamber and machine down time. Despite control of substrate heating, valleys (lower deposition) can form at certain locations on substrates. Therefore, there is a need for apparatus and methods for improving heating uniformity.

Therefore, a need exists for improved processing chambers and related components that facilitate temperature adjustability and deposition adjustability.

### SUMMARY

The present disclosure relates to a heating apparatus including adjustable mirrors for process chambers, and related methods and apparatus for semiconductor manufacturing.

In one or more embodiments, a process chamber includes a chamber body at least partially defining a processing volume. A substrate support is disposed in the processing volume. A plurality of heat sources are operable to heat the processing volume. A support plate is disposed outwardly of the processing volume. One or more reflective surfaces are mounted to the support plate. The one or more reflective surfaces are operable to direct radiation to a target location in the processing volume by moving about at least one axis.

In one or more embodiments, a process chamber includes a chamber body at least partially defining a processing volume. A substrate support is disposed in the processing volume. A gas inlet is formed at least partially in a sidewall of the chamber body. The process chamber further includes a heat assembly including a digital micromirror device (DMD) operable to direct energy to a target location in the processing volume and a heat source oriented to emit the energy toward the DMD.

In one or more embodiments, a method of heating a substrate includes positioning a substrate on a substrate support disposed within a processing volume and emitting energy from one or more heat sources and toward the substrate. The method further includes pivoting at least one reflective surface to direct reflected energy toward a region of the substrate and generating a pattern of radiation on the substrate using the reflected energy.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of scope, as the disclosure may admit to other equally effective embodiments.

FIG. 1 is a schematic side cross-sectional view of a processing chamber, according to one or more embodiments.

FIGS. 2A and 2B are schematic side cross-sectional view of the plurality of upper heating elements and the one or more reflective surfaces disposed within the processing chamber, according to one or more embodiments.

FIGS. 3A-3D are schematic bottom views of the one or more reflective surfaces disposed within a plurality of fixed reflectors, according to one or more embodiments.

FIG. 4 is a schematic side cross-sectional view of a processing chamber, according to one or more embodiments.

FIG. 5 is an enlarged perspective view of a DMD, according to one or more embodiments.

FIG. 6 is a schematic side cross-sectional view of the DMD reflecting a plurality of reflections onto the substrate, according to one or more embodiments.

FIG. 7 is a schematic block diagram of a method of heating a substrate for semi-conductor processing, according to one or more embodiments.

FIG. 8 is a schematic top view of a reflector shown in FIGS. 1-4, according to one or more embodiments.

FIG. 9 is a schematic perspective view of a linear lamp for use within the processing chamber of FIG. 1 and/or the processing chamber of FIG. 4, according to one or more embodiments.

FIG. 10 is a schematic perspective view of a curved lamp for use within the processing chamber of FIG. 1 and/or the processing chamber of FIG. 4, according to one or more embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The present disclosure relates to a heating apparatus including adjustable mirrors for process chambers, and related methods and apparatus for semiconductor manufacturing. The present disclosure contemplates that adjustable reflective surfaces other than mirror surfaces can be used in place of the mirror surfaces described herein. For example, adjustable reflector structures other than mirrors can be used in place of the mirrors described herein.

The disclosure contemplates that terms such as “couples,” “coupling,” “couple,” and “coupled” may include but are not limited to embedding, bonding, welding, fusing, melting together, interference fitting, and/or fastening such as by using bolts, threaded connections, pins, and/or screws. The disclosure contemplates that terms such as “couples,” “coupling,” “couple,” and “coupled” may include but are not limited to integrally forming. The disclosure contemplates that terms such as “couples,” “coupling,” “couple,” and “coupled” may include but are not limited to direct coupling and/or indirect coupling, such as indirect coupling through components such as links, blocks, and/or frames.

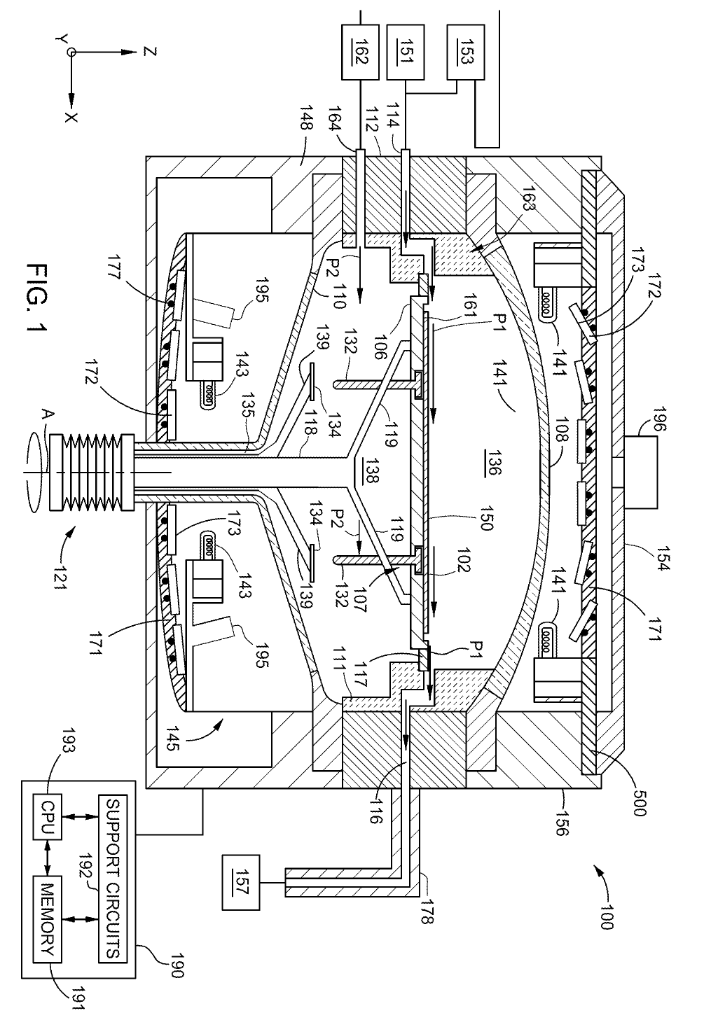

FIG. 1 is a schematic side cross-sectional view of a processing chamber 100, according to one or more embodiments. The processing chamber 100 is a deposition chamber. In one or more embodiments, the processing chamber 100 is an epitaxial deposition chamber. The processing chamber 100 is utilized to grow an epitaxial film on a substrate 102. The processing chamber 100 creates a cross-flow of precursors across an upper surface 150 of the substrate 102. The processing chamber 100 is shown in a processing condition in FIG. 1.

The processing chamber 100 includes an upper body 156, a lower body 148 disposed below the upper body 156, and a flow module 112 disposed between the upper body 156 and the lower body 148. The upper body 156, the flow module 112, and the lower body 148 form a chamber body. Disposed within the chamber body is a substrate support 106, an upper plate 108 (such as an upper window, for example an upper dome), a lower plate 110 (such as a lower window, for example a lower dome), a plurality of upper heat sources 141, and a plurality of lower heat sources 143. In one or more embodiments, the upper heat sources 141 include upper lamps and the lower heat sources 143 include lower lamps. The present disclosure contemplates that other heat sources may be used (in addition to or in place of the lamps) for the various heat sources described herein. For example, resistive heaters, light emitting diodes (LEDs), and/or lasers may be used for the various heat sources described herein.

The substrate support 106 is disposed between the upper plate 108 and the lower plate 110. The substrate support 106 supports the substrate 102. In one or more embodiments, the substrate support 106 includes a susceptor. Other substrate supports (including, for example, a substrate carrier and/or one or more ring segment(s) that support one or more outer regions of the substrate 102) are contemplated by the present disclosure. The plurality of upper heat sources 141 are disposed between the upper plate and a lid plate 154. The arrays of heat sources 141, 143 can be independently controlled in zones in order to control the temperature of various regions of the substrate 102 as the process gas passes thereover, thus facilitating the deposition of a material onto the upper surface of the substrate 102. While not discussed here in detail, the deposited material may include silicon, doped silicon, germanium, doped germanium, silicon germanium, doped silicon germanium, gallium arsenide, gallium nitride, or aluminum gallium nitride, among other materials.

The plurality of lower heat sources 143 are disposed between the lower plate 110 and a floor 152. The plurality of lower heat sources 143 form a portion of a lower heat source module 145. The upper plate 108 is an upper dome and/or is formed of an energy transmissive material, such as quartz. The lower plate 110 is a lower dome and/or is formed of an energy transmissive material, such as quartz.

A processing volume 136 and a purge volume 138 are formed between the upper plate 108 and the lower plate 110. The processing volume 136 and the purge volume 138 are part of an internal volume defined at least partially by the upper plate 108, the lower plate 110, and one or more liners 111, 163 of the chamber body. In one or more embodiments, the processing volume 136 is a processing volume.

The internal volume has the substrate support 106 disposed therein. The substrate support 106 includes a top surface 161 on which the substrate 102 is disposed. The substrate support 106 is attached to a shaft 118. In one or more embodiments, the substrate support 106 is connected to the shaft 118 through one or more arms 119 connected to the shaft 118. The shaft 118 is connected to a motion assembly 121. The motion assembly 121 includes one or more actuators and/or adjustment devices that provide movement and/or adjustment for the shaft 118 and/or the substrate support 106 within the processing volume 136.

The substrate support 106 may include lift pin holes 107 disposed therein. The lift pin holes 107 are each sized to accommodate a lift pin 132 for lifting of the substrate 102 from the substrate support 106 before or after a deposition process is performed. The lift pins 132 may rest on lift pin stops 134 when the substrate support 106 is lowered from a process position to a transfer position. The lift pin stops 134 can include a plurality of arms 139 that attach to a shaft 135.

The flow module 112 includes one or more gas inlets 114 (e.g., a plurality of gas inlets), one or more purge gas inlets 164 (e.g., a plurality of purge gas inlets), and one or more gas exhaust outlets 116. The one or more gas inlets 114 and the one or more purge gas inlets 164 are disposed on the opposite side of the flow module 112 from the one or more gas exhaust outlets 116.

A pre-heat ring 117 is disposed below the one or more gas inlets 114 and the one or more gas exhaust outlets 116. The pre-heat ring 117 is disposed above the one or more purge gas inlets 164. The pre-heat ring 117 is disposed at least partially outwardly of the substrate support 106. The one or more liners 111, 163 are disposed on an inner surface of the flow module 112 and protect the flow module 112 from reactive gases used during deposition operations and/or cleaning operations. The gas inlet(s) 114 and the purge gas inlet(s) 164 are each positioned to flow a respective one or more process gases P1 and one or more purge gases P2 parallel to the upper surface 150 of a substrate 102 disposed within the processing volume 136. The gas inlet(s) 114 are fluidly connected to one or more process gas sources 151 and one or more cleaning gas sources 153. The purge gas inlet(s) 164 are fluidly connected to one or more purge gas sources 162. The one or more gas exhaust outlets 116 are fluidly connected to an exhaust pump 157. The one or more process gases P1 supplied using the one or more process gas sources 151 can include one or more reactive gases (such as one or more of silicon (Si), phosphorus (P), and/or germanium (Ge)) and/or one or more carrier gases (such as one or more of nitrogen (N₂) and/or hydrogen (H₂)). The one or more purge gases P2 supplied using the one or more purge gas sources 162 can include one or more inert gases (such as one or more of argon (Ar), helium (He), and/or nitrogen (N₂)). One or more cleaning gases supplied using the one or more cleaning gas sources 153 can include one or more of hydrogen (H) and/or chlorine (Cl). In one or more embodiments, the one or more process gases P1 include one or more silicon-containing gases (such as silane and/or silicon phosphide (SiP)) and/or phosphine (PH₃), and the one or more cleaning gases include hydrochloric acid (HCl).

The one or more gas exhaust outlets 116 are further connected to or include an exhaust system 178. The exhaust system 178 fluidly connects the one or more gas exhaust outlets 116 and the exhaust pump 157. The exhaust system 178 can assist in the controlled deposition of a layer on the substrate 102. The exhaust system 178 is disposed on an opposite side of the processing chamber 100 relative to the flow module 112.

The processing chamber 100 includes the one or more liners 111, 163 (e.g., a lower liner 111 and an upper liner 163). The lower liner 111 and the upper liner 163 are disposed inwardly of a sidewall (e.g., the flow module 112 and/or the upper body 156) of the chamber body. The flow module 112 (which can be at least part of the sidewall of the processing chamber 100) includes the one or more gas inlets 114 in fluid communication with the processing volume 136. The one or more gas inlets 114 are in fluid communication with one or more flow gaps between the upper liner 163 and a lower liner 111. The one or more of the liners 111, 163 include one or more ledges supporting the pre-heat ring 117.

A reflector support 171 is disposed between the plurality of upper heat sources 141 and the lid plate 154. One or more reflective surface 173 are mounted to the reflector support 171. In one or more embodiments, the one or more reflective surfaces 173 are part of one or more mirrors 172 mounted to the reflector support 171. As described above, the one or more reflective surfaces 173 can be part of reflector structures other than mirrors. The references to the mirrors 172 is exemplary and the description of the mirrors 172 throughout is also applicable, for example, to the other structures (such as other reflector structures) that can be used in place of the mirrors 172. Each of the one or more reflective surfaces 173 can be rotated along at least one axis to direct light from the plurality of upper heat sources 141 towards the substrate 102. In one or more embodiments, each reflective surface 173 can be rotated in one dimension along a single axis from 1 degree to 30 degrees. In one or more embodiments, each reflective surface 173 can be rotated in two dimensions along two axes from 1 degree to 30 degrees. The reflective surfaces 173 (as part of, e.g., the mirrors 172) can be moved using a variety of methods such as mechanically, electrically (such as by applying a voltage to a digital micromirror device “DMD”), electromagnetically, or a combination thereof. For example, the reflective surfaces 173 can be mechanically rotated about an axis using a shaft coupled to the mirrors 172. As another example, the reflective surfaces 173 can be electrically moved by applying voltage (such as in a micro-electromechanical system (MEMS), a digital lithography product (DLP), or a digital micromirror device (DMD)). As a further example, the reflective surfaces 173 can be rotated using an axis (such as a shaft) disposed in a coil.

The one or more reflective surfaces 173 include a coating 272 to reflect electromagnetic radiation off of a surface of each reflective surface 173. The coating 272 can be disposed on the respective reflective surface 173, or the coating 272 can be disposed on the mirror 172 and the respective reflective surface 173 can be part of the coating 272. The coating 272 is disposed on the front surface of each mirror 172, the back surface of each mirror 172, or a combination thereof. In one or more embodiments, the coating 272 is applied to the one or more mirrors can be selected to emit a desired range of wavelengths of electromagnetic radiation. For example, in one or more embodiments the coating 272 applied to the one or more mirrors 172 can be selected to only reflect a range of wavelengths within the infrared (IR) spectrum. It should be understood that the spectrum of electromagnetic radiation that is reflected by the mirrors 172 can be customized by selecting the coating applied to the one or more mirrors including IR, ultraviolet (UV) light, and visible light. In one or more embodiments, the wavelength is from about 600nm to about 1.5 microns. In one or more embodiments, the reflector support 171 includes a plurality of cooling channels 177. The cooling channels 177 can prevent overheating of chamber components, such as the mirrors 172. For example, the cooling channels can prevent the coating applied to the one or more mirrors 172 from being damaged due to high temperatures within the processing chamber 100. The cooling channels 177 can maintain the reflector support 171 at a temperature under 100 degrees Celsius.

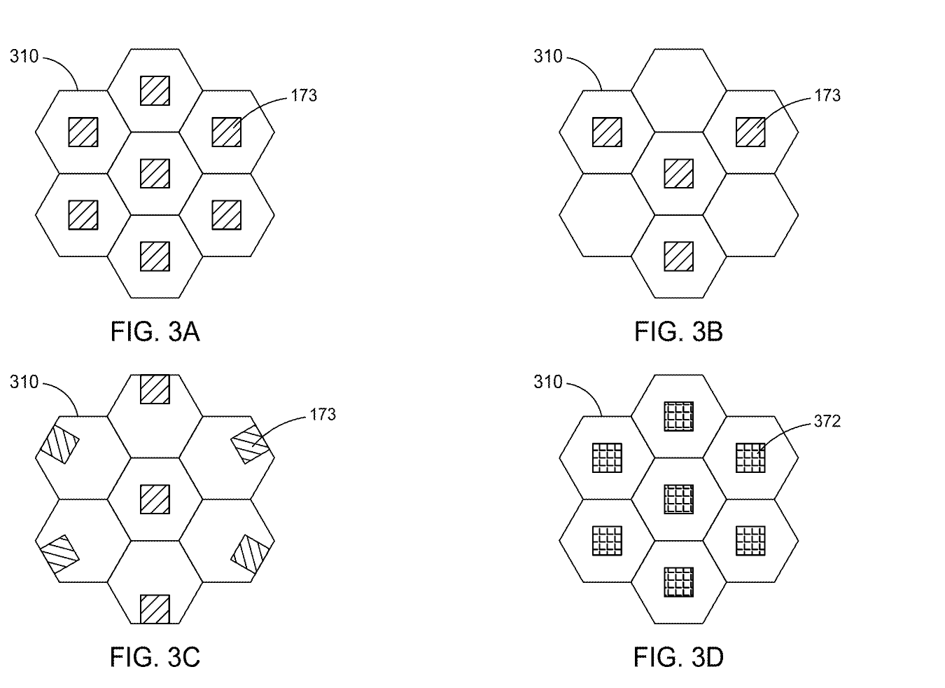

In one or more embodiments, each reflective surface 173 is disposed within a section of a reflector plate 310 coupled to the reflector support 171 as described in greater detail in FIGS. 3A-3D. In one or more embodiments, one or more reflector plates 310 are coupled to the reflector support 171 between the reflector support 171 and the reflective surfaces 173. In one or more embodiments, the reflector support 171 is a reflector plate 310 as described as described in greater detail in FIGS. 3A-3D.

During a heating operation the plurality of upper heat sources 141 emit radiation energy such as ultraviolet (UV) light, visible light, infrared (IR) light, or a combination thereof. The radiation energy is emitted from the plurality of upper heat sources 141 towards the one or more reflective surfaces 173. The one or more reflective surfaces 173 reflect the radiation energy towards a desired area of the substrate 102. In one or more embodiments, the one or more reflective surfaces 173 reflect the radiation energy to a target location on a surface of the substrate 102. The one or more reflective surfaces 173 can each be controlled separately from one another to direct the one or more light beams towards different areas on the substrate.

In one or more embodiments, the processing chamber 100 includes one or more reflective surfaces 173 disposed on a reflector support 171 adjacent the floor 152 and below the plurality of lower heat sources 143. During a heating operation the plurality of lower heat sources 143 emit electromagnetic radiation energy such as ultraviolet (UV) light, visible light, infrared (IR) light, or a combination thereof. The radiation energy is emitted from the plurality of lower heat sources 143 towards the one or more reflective surfaces 173. The one or more reflective surfaces 173 reflect the radiation energy towards a desired area of the substrate 102. In one or more embodiments, the one or more reflective surfaces 173 reflect the radiation energy to a concentrated area on a surface of the substrate 102. The one or more reflective surfaces 173 can each be controlled separately from one another to direct the radiation energy towards different areas on the substrate. In one or more embodiments, the processing chamber 100 includes one or more reflective surfaces 173 above the plurality of upper heat sources 141 and one or more reflective surfaces 173 below the plurality of lower heat sources 143.

The processing system includes one or more sensors 195, 196 (e.g., temperature sensors) configured to measure parameter(s) (e.g., temperature(s)) within the processing chamber 100. The one or more sensors 195, 196 can directly measure emitted energy from the substrate 102 and/or chamber components. In one or more embodiments, the one or more sensors 195, 196 are configured to measure the electromagnetic energy reflected off of the substrate 102 and/or chamber components. In one or more embodiments, the one or more sensors 195, 196 include an upper sensor 196 and one or more lower sensors 195. A controller 190 (described below) can control the one or more sensors 195, 196, the one or more reflective surfaces 173 (as part of structures such as the one or more mirrors 172), and/or one or more heat sources 141, 143, and can conduct method(s) of adjusting uniformity of substrate processing using at least one of the one or more sensors 195, 196, the one or more reflective surfaces 173 (as part of structures such as the one or more mirrors 172), and/or one or more heat sources 141, 143. In one or more embodiments, one or more sensors 195, 196 each include a pyrometer, such as a pyrometer that includes a silicon sensor. In one or more embodiments, each sensor 195, 196 is an optical sensor, such as an optical pyrometer. The present disclosure contemplates that sensors other than pyrometers may be used, and/or one or more of the sensors 195, 196 can measure properties other than temperature. In one or more embodiments, one or more sensors 195, 196 each include an infrared (IR) camera, such as a line scan IR camera.

In one or more embodiments, the sensors 195, 196 include one or more upper sensors 196 disposed above the substrate 102 and adjacent the lid plate 154, and one or more lower sensors 195 disposed below the substrate 102 and adjacent the floor 152. The present disclosure contemplates that at least one of the one or more lower sensors 195 can be vertically aligned below at least one of the upper sensors 196, 196.

Each sensor 195, 196 can be a single-wavelength sensor device or a multi-wavelength (such as dual-wavelength) sensor device. In one or more embodiments, the system including the process chamber 100 includes any one, any two, or any three of the four illustrated sensors 195, 196. In one or more embodiments, the process chamber 100 includes one or more additional sensors, in addition to the sensors 195, 196. The process chamber 100 may include sensors disposed at different locations and/or with different orientations than the illustrated sensors 195, 196. The one or more reflective surfaces 173 can be disposed at different locations and/or with different orientations than the illustrated sensors 195, 196.

The controller can receive the temperature measurements of the temperature sensors 195, 196 and control (such as rotate) the one or more reflective surfaces 173 to control (such as adjust) the temperature of one or more portions of the substrate 102. As an example, the controller can compare measured temperature(s) of an area on a surface of the substrate 102 to a target temperature and rotate the one or more reflective surfaces 173 based on the target temperature. The target temperature can be stored in a memory (such as the memory 191 of the controller 190 described below).

During a deposition operation (e.g., an epitaxial growth operation), the one or more process gases P1 flow through the one or more gas inlets 114, through the one or more gaps, and into the processing volume 136 to flow over the substrate 102. During the deposition operation, the plurality of heat sources 141, 143 are used to heat a portion of the substrate 102. The one or more process gases P1 flow over the pre-heat ring 117, which pre-activates the one or more process gases P1 for depositing film on the substrate 102 prior to flowing over the substrate 102. The plurality of heat sources 141, 143 using the one or more reflective surfaces 173 , facilitate deposition of film at a desired region of the substrate 102, which facilitates deposition uniformity (such as center-to-edge uniformity). The one or more reflective surfaces 173 facilitate deposition uniformity while facilitating reduced particle contamination of the substrate 102 and/or reduced degradation of chamber components.

The present disclosure also contemplates that the one or more purge gases P2 can be supplied to the purge volume 138 (through the one or more purge gas inlets 164) during the deposition operation, and exhausted from the purge volume 138. The one or more purge gases P2 flow simultaneously with the flowing of the one or more process gases P1. The one or more process gases P1 are exhausted through gaps between the upper liner 163 and the lower liner 111, and through the one or more gas exhaust outlets 116. The one or more purge gases P2 can be exhausted through one or more outlet openings, and through the same one or more gas exhaust outlets 116 as the one or more process gases P1. The present disclosure contemplates that that the one or more purge gases P2 can be separately exhausted through one or more second gas exhaust outlets that are separate from the one or more gas exhaust outlets 116.

During a cleaning operation, one or more cleaning gases flow through the one or more gas inlets 114, through the one or more gaps (between the upper liner 163 and the lower liner 111), and into the processing volume 136.

As shown, a controller 190 is in communication with the processing chamber 100 and is used to control processes and methods, such as the operations of the methods described herein.

The controller 190 is configured to receive data or input as sensor readings from sensor(s) (such as one or more of the sensors 195, 196) and/or as inputs from other devices. For example, the controller 190 can receive the data from another tool (such as another processing chamber) in the form of incoming substrate reading maps (e.g., including critical dimension data, feature depth data, in-substrate uniformity, or other incoming substrate data, such as other feature geometry features). The controller 190 can account for variations in the substrate reading maps across multiple substrates. The sensors can include, for example: sensors that monitor growth of layer(s) on the substrate 102; and/or sensors that monitor temperatures of the substrate 102, the substrate support 106, and/or the liners 111, 163. The controller 190 is equipped with or in communication with a system model of the processing chamber 100. The system model includes a heating model, a temperature uniformity model, a film uniformity model, a film deposition rate model, a coating model, a rotational position model, and/or a gas flow model. The system model is a program configured to estimate parameters (such as a signal profile (e.g., a temperature profile) of the substrate 102 and/or the substrate support 106, a gas flow rate, a gas pressure, a rotational position of component(s), a heating profile, a coating condition, and/or a cleaning condition) within the processing chamber 100 throughout a deposition operation and/or a cleaning operation. The controller 190 is further configured to store readings and calculations. The readings and calculations include previous sensor readings, such as any previous sensor readings within the processing chamber 100. The readings and calculations further include the stored calculated values from after the sensor readings are measured by the controller 190 and run through the system model. Therefore, the controller 190 is configured to both retrieve stored readings and calculations as well as save readings and calculations for future use. Maintaining previous readings and calculations enables the controller 190 to adjust the system model over time to reflect a more accurate version of the processing chamber 100.

The controller 190 can monitor heating, generate a signal profile (e.g., a temperature profile), identify set(s) of one or more heat sources, adjust a heating profile, adjusting heating power(s) (such as the power supplied to the plurality of heat sources 141, 143), adjust the position of the one or more reflective surfaces 173 and/or the one or more mirrors 172, estimate an optimized parameter (such as the target temperature), adjust the one or more sensors 195, 196, generate an alert on a display, halt a deposition operation, initiate a chamber downtime period, delay a subsequent iteration of the deposition operation, initiate a cleaning operation, halt the cleaning operation, and/or otherwise adjust the process recipe. In one or more embodiments, the controller 190 adjusts the positions of the reflective surfaces 173 (such as by moving the mirrors 172, for example pivoting or rotating the mirrors 172) in response to data or input (such as sensor readings).

The controller 190 includes a central processing unit (CPU) 193 (e.g., a processor), a memory 191 containing instructions, and support circuits 192 for the CPU 193. The controller 190 controls various items directly, or via other computers and/or controllers. In one or more embodiments, the controller 190 is communicatively coupled to dedicated controllers, and the controller 190 functions as a central controller.

The controller 190 is of any form of a general-purpose computer processor that is used in an industrial setting for controlling various substrate processing chambers and equipment, and sub-processors thereon or therein. The memory 191, or non-transitory computer readable medium, is one or more of a readily available memory such as random access memory (RAM), dynamic random access memory (DRAM), static RAM (SRAM), and synchronous dynamic RAM (SDRAM (e.g., DDR1, DDR2, DDR3, DDR3L, LPDDR3, DDR4, LPDDR4, and the like)), read only memory (ROM), floppy disk, hard disk, flash drive, or any other form of digital storage, local or remote. The support circuits 192 of the controller 190 are coupled to the CPU 193 for supporting the CPU 193. The support circuits 192 include cache, power supplies, clock circuits, input/output circuitry and subsystems, and the like. Operational parameters (e.g., target temperature(s) for the substrate 102, reading(s), signal difference(s), signal profile(s), heating power(s) (e.g., applied to the one or more of the heat sources 141, 143), adjustment factor(s), threshold ratio(s), range(s) and/or training range(s) with which the signal difference(s) are compared, a cleaning recipe, and/or a processing recipe) and operations are stored in the memory 191 as a software routine that is executed or invoked to turn the controller 190 into a specific purpose controller to control the operations of the various chambers/modules described herein. The controller 190 is configured to conduct any of the operations described herein. The instructions stored on the memory, when executed, cause one or more of the operations described herein (such as the deposition operation) to be conducted in relation to the processing chamber 100. The controller 190 and the processing chamber 100 are at least part of a system for processing substrates.

The various operations described herein (such as operations of the method 700) can be conducted automatically using the controller 190, or can be conducted automatically or manually with certain operations conducted by a user.

In one or more embodiments, the controller 190 includes a mass storage device, an input control unit, and a display unit. The controller 190 can monitor the temperature of the substrate 102, the temperature of the substrate support 106, the process gas flow, and/or the purge gas flow. In one or more embodiments, the controller 190 includes multiple controllers 190, such that the stored readings and calculations and the system model are stored within a separate controller from the controller 190 which controls the operations of the processing chamber 100. In one or more embodiments, all of the system model and the stored readings and calculations are saved within the controller 190.

The controller 190 is configured to control the deposition, the cleaning, the rotational position, the heating, and gas flow through the processing chamber 100 by providing an output to the controls for the sensors 195, 196, the one or more reflective surfaces 173, the upper heat sources 141, the lower heat sources 143, the process gas source 151, the purge gas source 162, the motion assembly 121, and/or the exhaust pump 157.

The controller 190 is configured to adjust the output to the controls based on the sensor readings, the system model, and the stored readings and calculations. The controller 190 includes embedded software and a compensation algorithm to calibrate measurements. The controller 190 can include one or more machine learning algorithms and/or artificial intelligence algorithms that estimate optimized parameters (such as the target temperature(s) for the substrate 102) for the uniformity analysis operations, the deposition operations, and/or the cleaning operations.

The one or more machine learning algorithms and/or artificial intelligence algorithms may implement, adjust and/or refine one or more algorithms, inputs, outputs or variables described above. Additionally or alternatively, the one or more machine learning algorithms and/or artificial intelligence algorithms may rank or prioritize certain aspects of adjustments of the process chamber 100 and/or method(s) relative to other aspects of the process chamber 100 and/or method(s) (such as the method 700). The one or more machine learning algorithms and/or artificial intelligence algorithms may account for other changes within the processing systems such as hardware replacement and/or degradation. In one or more embodiments, the one or more machine learning algorithms and/or artificial intelligence algorithms account for upstream or downstream changes that may occur in the processing system due to variable changes of the process chamber 100 and/or method(s). For example, if variable “A” is adjusted to cause a change in aspect “B” of the process, and such an adjustment unintentionally causes a change in aspect “C” of the process, then the one or more machine learning algorithms and/or artificial intelligence algorithms may take such a change of aspect “C” into account. In such an embodiment, the one or more machine learning algorithms and/or artificial intelligence algorithms embody predictive aspects related to implementing the process chamber 100 and/or the method(s). The predictive aspects can be utilized to preemptively mitigate unintended changes within a processing system.

The one or more machine learning algorithms and/or artificial intelligence algorithms can use, for example, a regression model (such as a linear regression model) or a clustering technique to estimate optimized parameters. The algorithm can be unsupervised or supervised. The one or more machine learning algorithms and/or artificial intelligence algorithms can optimize, for example, optimized parameters such as target temperature(s), reading(s), signal difference(s), signal profile(s), heating power(s), adjustment factor(s), threshold ratio(s), range(s), and/or training range(s) with which the signal difference(s) are compared, a cleaning recipe, and/or a processing recipe.

In one or more embodiments, the controller 190 automatically conducts the operations described herein without the use of one or more machine learning algorithms and/or artificial intelligence algorithms. In one or more embodiments, the controller 190 compares measurements (such as readings and/or signal differences for temperature measurements) to data in a look-up table and/or a library to identify a set of one or more heat sources. The controller 190 can stored measurements as data in the look-up table and/or the library.

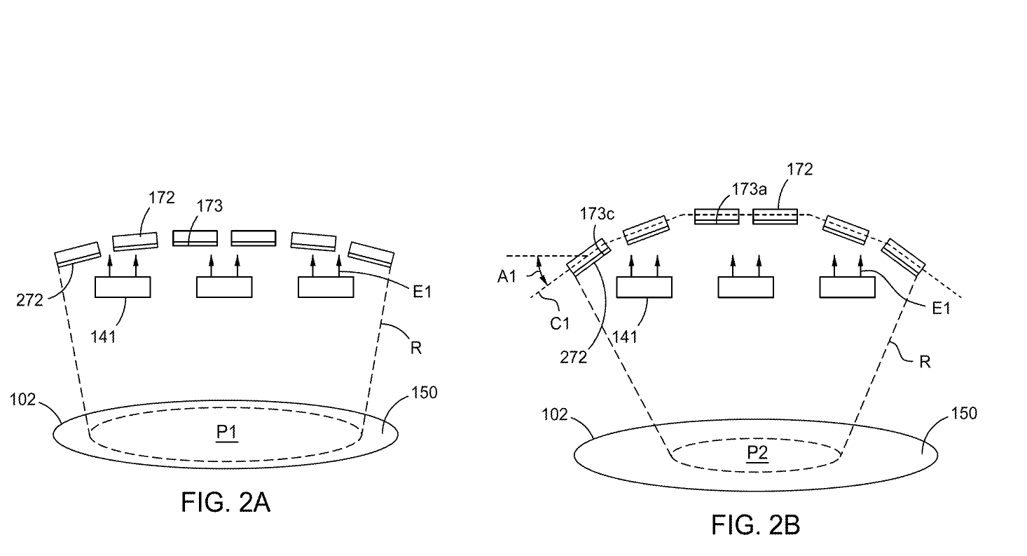

FIGS. 2A and 2B are schematic side cross-sectional views of the plurality of upper heat sources 141 and the one or more reflective surfaces 173 disposed within the processing chamber 100, according to one or more embodiments.

FIG. 2A shows the one or more reflective surfaces 173 in a first position. In one or more embodiments, when the reflective surfaces 173 are in the first position the reflective surfaces 173 reflect the radiation energy E1 emitted by the plurality of upper heat sources 141. The energy E1 is reflected by the reflective surfaces 173 as reflected energy R. The one or more reflections R are reflected onto a first area of the substrate as a first pattern P1. Although the first pattern P1 is depicted as a circular area encompassing a majority on the upper surface 150 of the substrate 102, it should be understood that this has been done for illustrative purposes and that the first pattern P1 can include any shape, size, and position on the substrate. For example, the first pattern P1 can be a circle, oval, square, rectangle, hexagon, octagon, ring, line strip, grid, or any other polygonal shape that the one or more reflective surfaces 173 can reflect the energy E1 onto the substrate. In one or more embodiments, the first pattern P1 covers the entire upper surface 150 of the substrate 102. In one or more embodiments, the first pattern P1 includes multiple areas on the upper surface 150 of the substrate 102. For example, the one or more reflective surfaces 173 can reflect the energy E1 emitted by the plurality of upper heat sources 141 onto two circular areas located at different positions on the upper surface 150 of the substrate 102.

FIG. 2B shows the one or more reflective surfaces 173 in a second position. In one or more embodiments, when the reflective surfaces 173 are in the second position the reflective surfaces 173 reflect the energy E1 emitted by the plurality of upper heat sources 141 one or more reflections R. The one or more reflections R are reflected onto a second area of the substrate as a second pattern P2. The second pattern P2 is different from the first pattern P1. Although the second pattern P2 is depicted as a circular area on the upper surface 150 of the substrate 102 smaller than the first pattern P1, it should be understood that this has been done for illustrative purposes and that the second pattern P2 can include any shape, size, and position on the substrate. For example, the second pattern P2 can be a circle, oval, square, rectangle, hexagon, octagon, ring, line strip, or any other shape that the one or more reflective surfaces 173 can reflect the energy E1 onto the substrate. In one or more embodiments, the second pattern P2 covers the entire upper surface 150 of the substrate 102. In one or more embodiments, the second pattern P2 includes multiple areas on the upper surface 150 of the substrate 102. For example, the one or more reflective surfaces 173 can reflect the energy E1 emitted by the plurality of upper heat sources 141 onto two circular areas located at different positions on the upper surface 150 of the substrate 102. In one or more embodiments, the reflective surfaces 173 reflect energy E1 toward the second pattern P2 that corresponds to an inner region of the substrate 102.

In order to change the one or more reflective surfaces 173 from the first position to the second position, at least one of the one or more reflective surfaces 173 are rotated to a different position. In one or more embodiments, the controller 190 controls the position of each reflective surface 173 of the one or more reflective surfaces 173 in the first position and the second position. It is contemplated that each reflective surface of the one or more reflective surfaces 173 can be controlled independently from one another. Each reflective surface 173 of the one or more reflective surfaces 173 can be rotated to any number of positions. In one or more embodiments, the reflective surfaces 173 are individually adjusted to achieve a curved profile C1 (such as an arc profile or a serpentine profile) extending through the reflective surfaces 173. In one or more embodiments, at least one outer reflective surface 173c is moved to have a larger angle A1 than at least one inner reflective surface 173a. In one or more embodiments, the reflective surfaces 173 are adjusted such that the angle A1 of the respective reflective surfaces 173 gradually increases in a radially outward direction.

FIGS. 3A-3D are schematic bottom views of the one or more reflective surfaces 173 disposed within a plurality of fixed reflectors, according to one or more embodiments. In one or more embodiments, the reflectors are a plurality of reflector sections 310 disposed between the reflector support 171 and the mirrors. In one or more embodiments, the reflector support 171 serves as the reflector. The reflector may include a plurality of flat plates, a plurality of curved plates, a single flat plate, a single curved plate, a plate including a plurality of grooves, a plate including a plurality of openings configured to receive one or more heating elements, or a combination thereof. In one or more embodiments, the reflector support 171 includes a plurality of grooves that respectively receive linear lamps (such as U-shaped lamps that include electrical connectors extending through the reflector support 171).

FIG. 3A shows a plurality of reflective surfaces 173 disposed within the center of a plurality of reflector sections 310. In one or more embodiments, the each reflector section 310 is disposed between the reflective surfaces 173 and the reflector support 171. In one or more embodiments, each reflector section 310 if formed of a reflective material. The reflective material can include metal materials such as gold, silver, aluminum (such as polished aluminum), steel (such as polished steel), machined aluminum with gold plating, and/or stainless steel with gold plating. In one or more embodiments, a plurality of reflector sections 310 can be arranged on the reflector support 171. In one or more embodiments, a reflective surface 173 is disposed in the center of each reflector section 310. The reflector sections 310 help reflect electromagnetic radiation emitted from the plurality of heat sources 141, 143 towards the substrate 102. Although the reflector sections 310 are shown having a hexagonal shape, it should be understood that this has been done for illustrative purposes and that the reflector sections 310 can include any shape such as circles, squares, rectangles, ovals, rings, octagons, line strip, and/or other shape(s). The reflector sections 310 can be virtually separated without physical structure or can be separated using physical structures (such as walls).

FIG. 3B shows a plurality of reflective surfaces 173 disposed within the center of a portion of the reflectors 310 of the plurality of reflector sections 310. In one or more embodiments, a portion of the reflectors 310 of the plurality of reflector sections 310 include a reflective surface 173. In one or more embodiments, a reflective surface 173 is disposed in alternating reflector sections 310 of the plurality of reflector sections 310. In one or more embodiments, a first portion of reflector sections 310 include reflective surfaces 173 and a second portion of reflectors 310 do not include reflective surfaces 173. In one or more embodiments, only one reflector section 310 includes a reflective surface 173. It is contemplated that any number of reflector sections 310 within the plurality of reflector sections 310 may include one or more reflective surfaces 173 disposed therein.

FIG. 3C shows a plurality of reflective surfaces 173 disposed along an outer edge of a portion of the reflector sections 310 of the plurality of reflector sections 310. In one or more embodiments, the reflective surfaces 173 are disposed among an edge of each mirror’s respective reflector section 310. It is contemplated that each reflective surface 173 can be disposed anywhere within a reflector section 310 such as along an outer edge of a reflector section 310, within the center of the reflector section 310, along another position, or a combination thereof. As such, the present disclosure contemplates other positions and/or arrangements for the reflective surfaces 173.

FIG. 3D shows a plurality of micrormirror devices 372 disposed within a plurality of reflectors 310. Each micromirror device 372 includes a plurality of micromirrors. Each micromirror within the micromirror device 372 can be controlled independently from one another. It is contemplated that the embodiments shown in FIGS. 3A, 3B, 3C and 3D may be combined.

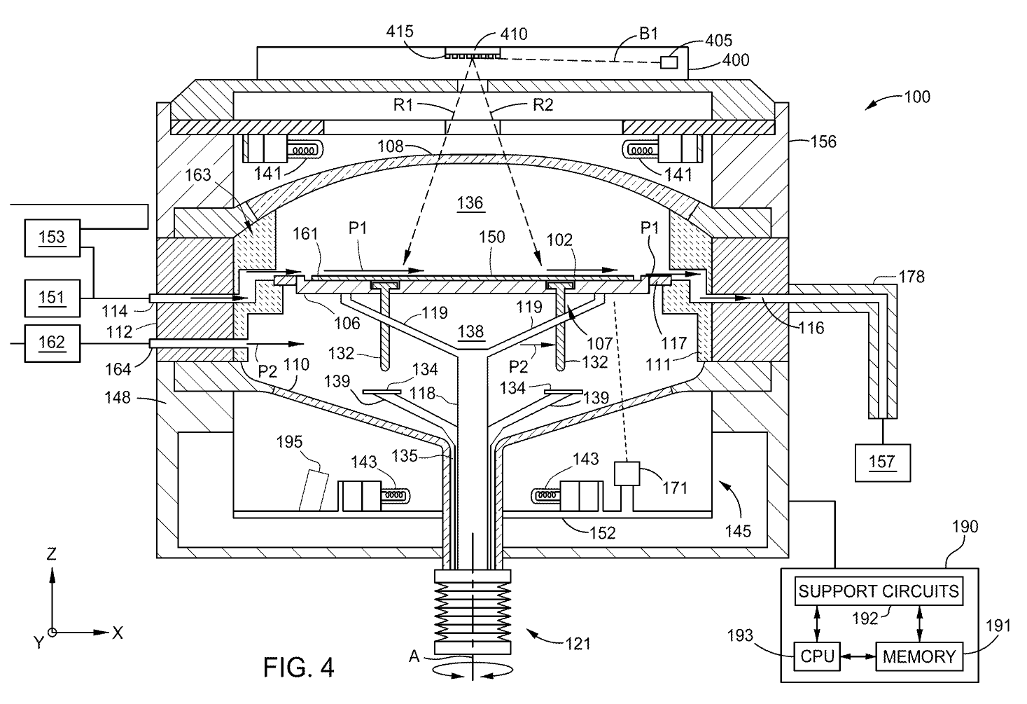

FIG. 4 is a schematic side cross-sectional view of a processing chamber 100, according to one or more embodiments. The processing chamber 100 shown in FIG. 4 includes a heat source assembly 400. In one or more embodiments, the heat source assembly 400 is coupled to the lid plate 154. The heat source assembly 400 includes a plurality of cooling channels. The heat source assembly includes one or more radiation sources 405 and a digital micromirror device (DMD) 410. In one or more embodiments, the one or more radiation sources 405 includes a laser source. The DMD 410 includes a plurality of micromirrors 415 disposed on a surface of the DMD 410. Each of the micromirrors 415 can be controlled independently from one another.

During a heating operation the one or beams B1 of electromagnetic radiation or emitted by the one or more radiation sources 405 towards the DMD 410. The one or more beams B1 are reflected by each of the micromirrors 415 of the DMD 410 towards substrate 102. The one or more beams B1 are reflected by the plurality of micromirrors 415 as a plurality of reflections. The plurality of reflections include at least a first reflection R1 and a second reflection R2. The first reflection R1 is reflected towards a first location on the upper surface 150 of the substrate 102. The second reflection R2 is reflected towards a second location on the upper surface 150 of the substrate 102. The micromirrors 415 on the DMD 410 can any form any number of reflections. The reflections can directed towards any location on the substrate 102. The plurality of reflections R1, R2 can create a desired pattern on the substrate 102 to allow for a high degree of control of a temperature profile across the substrate 102. In one or more embodiments, the controller 190 determines pattern generated by the plurality of reflections R1, R2 by individually controlling each micromirror 415 on the DMD 410.

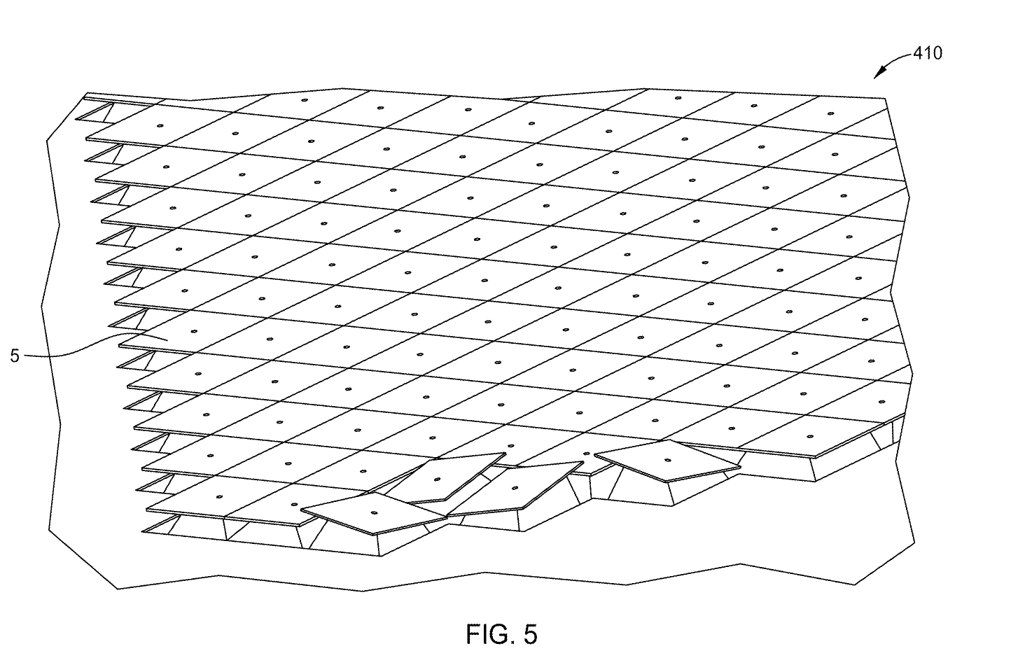

FIG. 5 is an enlarged perspective view of a DMD 410, according to one or more embodiments. The DMD 410 includes a plurality of micromirrors 415. Each micromirror 415 is rotatable in at least one dimension along a single axis. In one or more embodiments, each micromirror 415 can be rotated in two dimensions along two axes. The axes can be perpendicular with respect to each other. Each micromirror 415 can be controlled independently from one another. The controller 190 determines the position of each reflective surface (e.g., each micromirror 415) to generate any desired pattern of reflections on the upper surface 150 of the substrate 102.

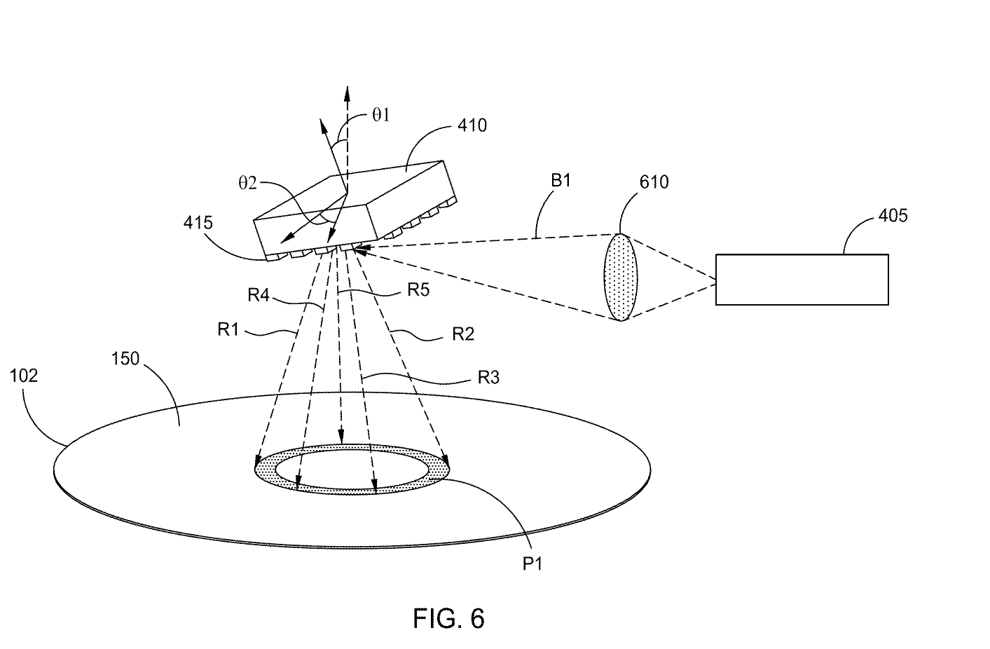

FIG. 6 is a schematic side cross-sectional view of the DMD 410 reflecting a plurality of reflections onto the substrate 102, according to one or more embodiments.

During a heating operation the one or beams B1 of electromagnetic radiation or emitted by the one or more radiation sources 405 towards the DMD 410. In one or more embodiments, the one or beams B1 are emitted towards a lens 610. The lens 610 focuses the one or beams B1 onto a desired area on the DMD 410. In one or more embodiments, the lens 610 is a variable zoom lens. In one or more embodiments, the lens 610 is movable along a length between the DMD 410 and the one or more radiation sources 405. The position of the variable zoom lens 610 is determined by the controller 190. By adjusting the position of the variable zoom lens the controller 190 can determine the location and the intensity of the one or more beams B1 emitted towards the DMD 410. The DMD 410 can moved in order to direct the one or more beams to the desired area. In one or more embodiments, the DMD 410 can be rotated to be offset from a first axis at first angle θ1 and/or to be offset from a second axis at a second angle θ2. In one or more embodiments, each micromirror 415 can be rotated along the first axis at a first angle θ1 and/or the second axis at a second angle θ2.

The one or more beams B1 are reflected by each of the micromirrors 415 of the DMD 410 towards the substrate 102. The micromirrors on the DMD generate a plurality of reflection used to reflect a pattern onto the upper surface 150 of the substrate 102. For example, as shown in FIG. 6 the plurality of micromirrors 415 of the DMD 410 reflect at least a first reflection R1, a second reflection R2, a third reflection R3, a fourth reflection R4, and a fifth reflection R5. The reflections are each directed to a desired location on the substrate 102 to create a pattern. For example, the first reflection R1 is directed towards a first location, the second reflection R2 is directed towards a second location, the third reflection R3 is directed towards a third location, the fourth reflection R4 is directed towards a fourth location and the fifth reflection R5 is directed towards a firth location. It should be understood that although FIG. 6 is shown including five reflections, in reality any number of reflections can be generated by the DMD. The reflections R1, R2, R3, R4, R5 together create a pattern P1. The pattern P1 is determined by the controller 190 in order to create desired temperature profile across the substrate 102. For example, in FIG. 6 the pattern P1 has a ring shape. In reality however, the pattern could have a desired shape in order to generate the desired temperature profile across the substrate 102. In one or more embodiments, multiple patterns are generated by the DMD 410 in order to generate the desired temperature profile across the substrate 102. The pattern of reflections generated by the DMD gives the controller 190 gives a high degree of control of temperature profile by controlling beam intensity, controlling the pattern size by adjusting the zoom of lens 610, and/or controlling the pattern shape by adjusting the micromirrors 415.

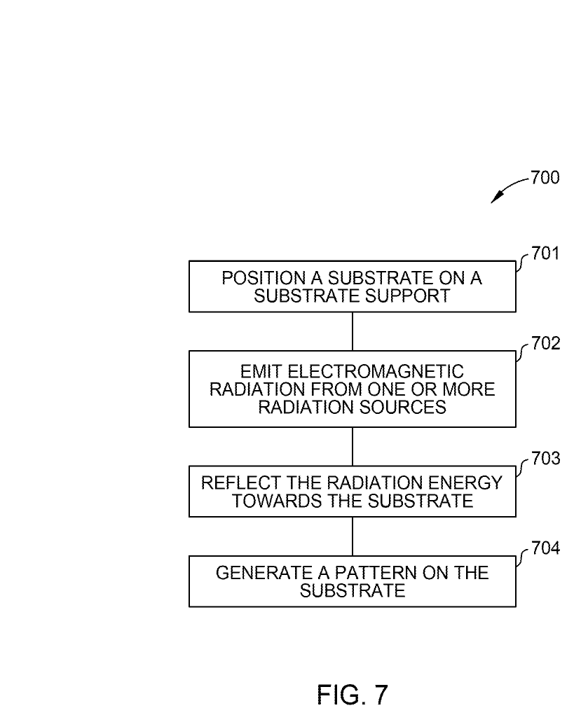

FIG. 7 is a schematic block diagram of a method 700 of heating a substrate for semi-conductor processing, according to one or more embodiments. In one or more embodiments, the method 700 is performed using one or more components of the processing chamber 100 described herein.

Operation 701 of method 700 includes positioning a substrate on a substrate support in a processing volume of a processing chamber. In one or more embodiments, the positioning includes moving a substrate support and/or a plurality of lift pins relative to each other to land the substrate on the substrate support.

Operation 702 of method 700 includes emitting electromagnetic radiation energy from one or more radiation sources. In one or more embodiments, the energy is emitted from at least of the heat sources from the plurality of heat sources 141, 143 of the processing chamber 100. In one or more embodiments, the energy is emitted from at least one of the one or more radiation sources 405 of the processing chamber 100. The energy can include any spectrum of electromagnetic radiation including IR energy, UV energy, and visible light.

Operation 703 of method 700 includes reflecting the radiation energy towards the substrate using one or more mirrors. In one or more embodiments, the reflective surfaces 173 are disposed on a reflector support 171 disposed above the plurality of upper heat sources 141. In one or more embodiments, the reflective surfaces 173 are disposed on the floor 152 disposed below the plurality of lower heat sources 143. In one or more embodiments, the mirrors are a plurality of micromirrors 415 disposed on a DMD 410.

Operation 704 of method 700 includes generating a pattern on the substrate using the radiation energy. The pattern is used to generate a desired temperature profile across the substrate.

In one or more embodiments, a temperature sensor measures the temperature of the substrate. The position of the mirrors is adjusted based on the temperature of the substrate. In one or more embodiments, the temperature sensor send the substrate temperature to the controller. The controller then compares the measured temperature of the substrate to a target temperature and adjust the one or more mirrors based on the measured temperature and the target temperature. In one or more embodiments, this position of the mirrors are adjusted multiple times during a processing operation.

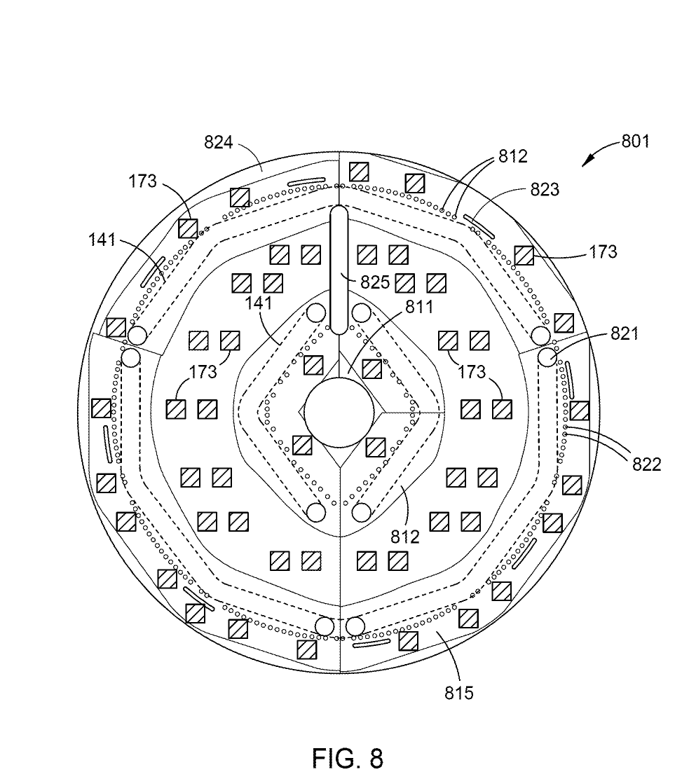

FIG. 8 is a schematic top view of a reflector 801 shown in FIGS. 1-4, according to one or more embodiments.

The reflector 801 includes one or more recessed surfaces 812 and a curved outer surface 815, which can be defined by a plurality of grooves formed in the reflector 801. The plurality of grooves are respectively configured to hold one or more horizontal heat sources 141 (such as linear heat sources) extending along the direction of the respective groove. Some of the heat sources 141 are shown in ghost in FIG. 8 for visual clarity purposes. The plurality of grooves are arranged to form concentric rings. The concentric rings can be hexagonal in shape.

The one or more recessed surfaces 812 and the curved outer surface 815 respectively include a set of first openings 821 having a first diameter, a set of second openings 822 having a second diameter smaller than the first diameter, and a set of slots 823 (e.g., elongated slots) having a length larger than the first diameter and the second diameter. The present disclosure contemplates that the second diameter can vary for the second openings 822. The first openings 821 allow an electrical connection and/or mechanical connection of the heat sources 141 to be disposed therethrough. A cooling fluid (such as air) can be flowed through the second openings 822 and/or the slots 823 to cool the reflector 801 and/or the heat sources 141. A slot 825 (e.g., an elongated slot) is formed in the reflector 801. The slot 825 can allow sensor device(s) (such as pyrometer(s)) to take measurements through the slot 825. For example, the slot 825 can provide a line of sight to at least one substrate 102, the first plate 108 shown in FIG. 1, and/or the substrate support 106 shown in FIG. 1. In one or more embodiments, the slot 825 extends at least partially into the curved outer surface 815 and at least one of the one or more recessed surfaces 812. The present disclosure contemplates that the inner surface 811, the one or more recessed surfaces 812, the curved outer surface 815, and/or the outer ledge 824 can respectively be divided into multiple sections, as shown in FIG. 8.

The reflector 801 can be used, for example, as one of more of the support plates 171 shown in FIG. 1. The reflector 801 can include the one or more reflective surfaces 173 (as shown in FIG. 8), the micromirror devices 372, the DMD 410, and/or the one or more radiation sources 405—collectively referred to as mirror devices in relation to FIG. 8. The mirror devices can be disposed on planar surfaces and/or curved surfaces (e.g., groove surfaces) of the reflector 801. The respective mirror devices can be disposed outwardly and/or inwardly of the respective arrays of heat sources141.

The reflector 801 can be made up of the reflector plates 310 and/or the reflector plates 310 can be coupled to the reflector 801 to mount the reflective surfaces 173 (as part of, for example, mirror devices) to the reflector 801.

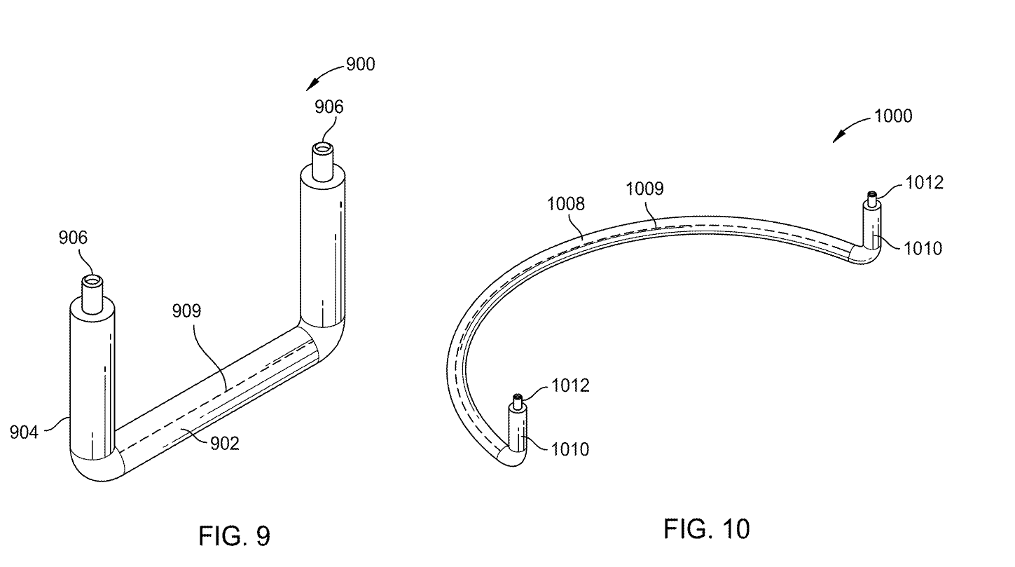

FIG. 9 is a schematic perspective view of a linear lamp 900 for use within the processing chamber 100 of FIG. 1 and/or the processing chamber 100 of FIG. 4, according to one or more embodiments. As an example the linear lamp 900 can be used as the upper heat sources 141 and/or the lower heat sources 143. The linear lamp 900 includes a linear bulb 902, one or more arms 904, and one or more electrical connections 906. In one or more embodiments, the linear lamps 900 are infrared (IR) halogen lamps. The linear bulb 902 is a cylindrical bulb with a filament 909 disposed therein. The linear bulb 902 is configured to emit a radiative energy, such as IR light, towards the substrate 102 when positioned within the processing chamber.

The one or more arms 904 extend from the linear bulb 902. As shown in FIG. 9, there are two arms 904 and one arm extends from each distal end of the linear bulb 902. The two arms 904 can extend in a direction perpendicular to the direction in which the linear bulb 902 extends. The present disclosure contemplates that the two arms 904 can extend obliquely relative to the linear bulb 902 to extend through an angled orientation of the first openings 821 shown in FIG. 8. The two arms 904 can extend in the same direction or can be angled to extend in opposite directions. At the end of each of the arms 904 is an electrical connection 906. The electrical connection 906 is configured to be plugged into or coupled to a socket or other power source. The electrical connections 906 are electrically coupled to the filament 909 within the linear bulb 902 and enable the linear lamp 900 to be powered.

FIG. 10 is a schematic perspective view of a curved lamp 1000 for use within the processing chamber 100 of FIG. 1 and/or the processing chamber 100 of FIG. 4, according to one or more embodiments.

The curved lamp 1000 includes a curved bulb 1008, one or more arms 1010, and one or more electrical connections 1012. The curved bulb 1008 is a tubular bulb shaped to form at least a portion of a ring, such as an arcuate ring. The curved bulb 1008 includes a filament 1009 disposed therein. The curved bulb 1008 is configured to emit a radiative energy towards the substrate 102 when positioned within the processing chamber.

The one or more arms 1010 extend from the curved bulb 1008. As shown in FIG. 10, there are two arms 1010, and one arm extends from each distal end of the curved bulb 1008. The arms 1010 can extend orthogonally or obliquely to a plane of the curved bulb 1008. The two arms 1010 extend in a direction perpendicularly or obliquely to the direction in which the curved bulb 1008 extends. The two arms 1010 can extend in the same direction are can be angled to extend in opposite directions. The arms 1010 extend through the first openings 821 of the reflector 801. At the end of each of the arms 1010 is an electrical connection 1012. The electrical connection 1012 is configured to be plugged into or coupled to a socket or other power source. The electrical connections 1012 are electrically coupled to a filament 1009 within the curved bulb 1008 and enable the curved lamp 1000 to be powered.

Benefits of the present disclosure include a greater control of the location and pattern of the energy used to heat substrate(s), temperature adjustability and/or uniformity, and processing (e.g., deposition) adjustability and/or uniformity. A variety of heating patterns can be generated. The greater control of the electromagnetic beams allows for a greater control of the temperature profile across a substrate during a processing operation, such as an epitaxial processing operation. The greater control the temperature profile across the substrate leads to decreased defects, increased device performance, increased throughput, decreased cost, and decreased maintenance of semi-conductor devices.

It is contemplated that one or more aspects disclosed herein may be combined. As an example, one or more aspects, features, components, operations and/or properties of the processing chamber 100, the substrate 102, the plurality of upper heat sources 141, the plurality of lower heat source 143, the reflector support 171, the reflective surfaces 173, the reflectors 310, the controller 190, the heat source assembly 400, the one or more radiation sources 405, the DMD 410, the micromirrors 415, the lens 610, and/or the method 700, the reflector 801, the linear lamp 900, and/or the curved lamp 1000 may be combined. Moreover, it is contemplated that one or more aspects disclosed herein may include some or all of the aforementioned benefits.

While the foregoing is directed to embodiments of the present disclosure, other and further embodiments of the disclosure may be devised without departing from the basic scope thereof, and the scope thereof is determined by the claims that follow.

What is claimed is:

1. A process chamber, comprising:
a chamber body at least partially defining a processing volume;
a substrate support disposed in the processing volume;
a plurality of heat sources operable to heat the processing volume;
a support plate disposed outwardly of the processing volume; and
one or more reflective surfaces mounted to the support plate, the one or more reflective surfaces operable to direct radiation to a target location in the processing volume by moving about at least one axis.

2. The process chamber of claim 1, wherein the one or more reflective surfaces include a plurality of reflective surfaces distributed across a grid pattern.

3. The process chamber of claim 2, wherein the grid pattern includes a plurality of polygonal shapes, and the plurality of reflective surfaces are respectively aligned with centers of the plurality of polygonal shapes.

4. The process chamber of claim 3, wherein at least one of the reflective surfaces is rotationally offset from at least one other mirror.

5. The process chamber of claim 1, further comprising:
a sensor operable to measure a temperature of the target location within the processing volume; and
a controller operable to rotate the one or more reflective surfaces independently from one another.

6. The process chamber of claim 1, wherein the one or more reflective surfaces are rotatable about two axes.

7. The process chamber of claim 1, wherein the one or more reflective surfaces are operable to pivot along an angle within a range of 1 degree to 35 degrees.

8. The process chamber of claim 1, wherein the one or more reflective surfaces comprise a coating configured to reflect a beam of electromagnetic radiation within a wavelength range of 600 nm to 1.5 microns.

9. The process chamber of claim 1, wherein the support plate comprises one or more cooling channels.

10. The process chamber of claim 1, wherein the one or more reflective surfaces comprise a plurality of micromirrors.

11. A process chamber, comprising:
a chamber body at least partially defining a processing volume;
a substrate support disposed in the processing volume;
a gas inlet formed at least partially in a sidewall of the chamber body; and
a heat assembly comprising:
a digital micromirror device (DMD) operable to direct energy to a target location in the processing volume, and
a heat source oriented to emit the energy toward the DMD.

12. The process chamber of claim 11, further comprising a sensor operable to measure a temperature of a target location within the processing volume.

13. The process chamber of claim 11, wherein the heat source is a laser source, and the DMD comprises a plurality of micromirrors.

14. The process chamber of claim 13, further comprising a controller operable to move the micromirrors independently from one another, wherein the plurality of micromirrors are rotatable about two axes.

15. The process chamber of claim 13, wherein the plurality of micromirrors comprise a coating configured to reflect a beam of electromagnetic radiation within a wavelength range of 600 nm to 1.5 microns.

16. The process chamber of claim 11, wherein the heat assembly further comprises a lens disposed between the DMD and the heat source.

17. The process chamber of claim 16, wherein the DMD is rotatable about two axes, and the lens is movable along a length between the DMD and the heat source.

18. A method of heating a substrate comprising:
positioning a substrate on a substrate support disposed within a processing volume;
emitting energy from one or more heat sources and toward the substrate;
pivoting at least one reflective surface to direct reflected energy toward a region of the substrate; and
generating a pattern of radiation on the substrate using the reflected energy.

19. The method of claim 18, wherein the pivoting positions a plurality of reflective surfaces to have a gradually increasing angle in a radially outward direction.

20. The method of claim 18, further comprising:
measuring a temperature of the substrate; and
adjusting the position of the at least one reflective surface based on the temperature of the substrate.
